(19) United States
(12) Patent Application Publication
(10) Pub. No.: US 2013/0151324 A1
(43) Pub. Date: Jun. 13, 2013

(54) Member profile website that identifies and/or acknowledges owners of verified as authentic designer goods; and whose registered members are verified owners of authentic designer handbags, apparel, jewelry, and/or accessories - for the purpose of negatively impacting the counterfeit goods industry and identifying and acknowledging buyers of authentic designer goods, thus exposing buyers of counterfeit designer goods.

(71) Applicant: JASMINE JUANITA HAPGOOD, Woodbridge, NJ (US)

(72) Inventor: JASMINE JUANITA HAPGOOD, Woodbridge, NJ (US)

(21) Appl. No.: 13/325,045

(22) Filed: Dec. 13, 2011

(51) Int. Cl. G06Q 30/02; G06F 17/30

(52) U.S. Cl. 705/14.25; 707/758; 707/706; 707/E17.108; 707/E17.014

(57) ABSTRACT

A member profile website that acknowledges and/or identifies owners of verified as authentic designer goods; and whose registered members are verified owners of authentic designer handbags, apparel, jewelry, and/or accessories—for the purpose of negatively impacting the counterfeit goods industry and identifying and acknowledging buyers of authentic designer goods, thus exposing buyers of counterfeit designer goods.

### BACKROUND OF THE INVENTION

1. Field of the Invention The present invention relates to user profile websites, and the counterfeit goods industry.

2. Description of the Related Art

Online user profiles are used in just about every industry to maintain customer records, accessible by the customer. Macy.com uses user profiles on their website to allow customers to save their personal preferences and information to be retrieved at a later time. Corporate companies use them to allow their employees to keep track of information relating to their employment with the company. Health insurance companies also use user profiles to allow beneficiaries to keep track of their insurance claims.

The counterfeit goods industry is a $600 billion industry. Both the US government and organizations such as the International Anti-Counterfeiting Coalition (IACC) are devoted to protecting intellectual property and deterring counterfeiting. Federal law enforcement conducts raids each year to in big cities such as New York City to plunder the merchandise in areas known for high counterfeit goods sales. According the ‘About Us’ page on www.iacc.org counterfeiting costs US businesses $200 billion to $250 billion annually.

Although there is no way to reveal each and every person who purchases counterfeit goods, there is a way to acknowledge those consumers who shun the counterfeit goods industry, and only purchase authentic merchandise—using the user profile phenomenon.

### BRIEF SUMMARY OF THE INVENTION

The present invention provides a method for identifying and acknowledging consumers who purchase authentic designer goods, thus exposing those consumers who purchase counterfeit designer goods.

In one embodiment, the method includes a member profile website where owners of authentic designer handbags, apparel, jewelry, and/or accessories have individual profiles on the website. In another embodiment, the method includes allowing anyone in the general public to search for a person using the search function on the website, for the purpose of determining if the designer merchandise they were seen wearing is authentic.

In another embodiment, the method includes issuing a membership card to persons who are members of the site and/or owners of authentic designer handbags, apparel, jewelry, and/or accessories, in order for the member to receive special treatment and/or discounts at retailers, businesses, and venues using the membership card.

### BRIEF DESCRIPTION OF THE SEVERAL VIEWS OF THE DRAWINGS

FIG. 1a depicts a web page search form where members/users can be searched for by name and location.

FIG. 1b depicts a successful search results page.

FIG. 1c depicts a failed search results page.

FIG. 2a depicts a user profile page.

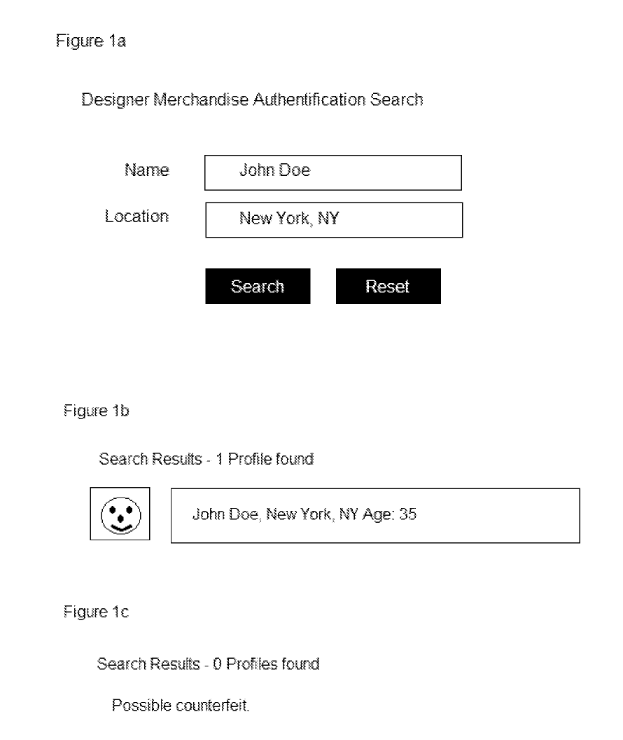

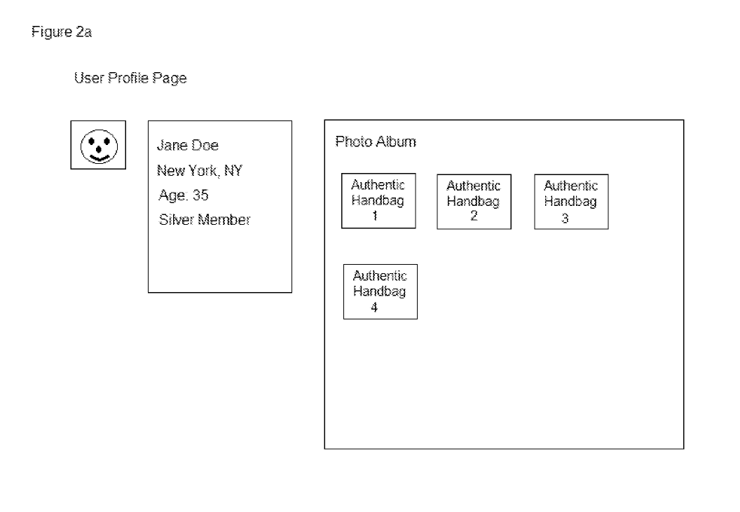

*Drawings and description explain function only. Design and layout of the actual web pages may differ.

### DETAILED DESCRIPTION OF THE INVENTION

A member profile website that identifies and/or acknowledges owners of verified as authentic designer goods; and whose registered members are verified owners of authentic designer handbags, apparel, jewelry, and/or accessories—for the purpose of negatively impacting the counterfeit goods industry and identifying and acknowledging buyers of authentic designer goods, thus exposing buyers of counterfeit designer goods.

The counterfeit goods industry is a $600 billion industry. There were 19,959 counterfeit-product seizures in fiscal year 2010, according to U.S. Customs and Border Protection (CBP) and U.S. Immigration and Customs Enforcement (ICE). The total domestic value of the fake goods seized was $188.1 million. Had the products been authentic, the total value of goods would have been $1.4 billion, based on manufacturers' suggested retail pricing.

Trade in counterfeit and pirated goods poses significant threats to the United States' innovation-based economy, the competitiveness of the nation's businesses, the livelihoods of U.S. workers and, in some cases, national security as well as the health and safety of consumers.

On websites such as ioffer.com that are notorious for selling counterfeit handbags, and where many of the sellers are located in China, buyers send publically displayed messages to the sellers requesting assurance that the replica handbag they are purchasing is an EXACT copy of the original. This proves that the buyers of these counterfeit handbags want those around them to think they are wearing the real thing without a doubt.

The idea behind this invention (using handbags as an example) is that if consumers knew that their friends and coworkers could simply go to a website to see if the designer handbag they are wearing is authentic, they would not purchase a counterfeit handbag—they would be too, embarrassed.

This invention provides consumers who purchase authentic designer goods with a profile on the website. Aside from their personal information and self-picture, the profile would consist of a photo album displaying any authentic designer merchandise they own. Anyone in the general public can search for a person by name and location using a search function on the website, to see if the designer merchandise they are wearing is authentic. If a profile appears, the merchandise is authentic. If an error message appears, the merchandise may be counterfeit. The counterfeit goods industry has stripped so many brands of the very thing that consumers who spend so much money for designer goods want—prestige and exclusivity. This invention gives them back those two elements.

What is claimed is:

1. A method comprising, by one or more computer systems of a website or online social network available to the general public via the internet or an extranet, or by one or more automated telephone systems available to the general public: acknowledgment and/or identification of verified owners of authentic designer handbags, apparel, jewelry, and/or accessories.

2. A method of claim 1, wherein the website or social network offers a publicly accessible, searchable database which consists of verified owners of authentic designer handbags, apparel, jewelry, and/or accessories.

3. A method of claim 2, wherein the database is available only to a select group of users via the internet or an extranet.

4. The method of claim 1, wherein verified owners of authentic designer handbags, apparel, jewelry, and/or accessories are given user profiles on the website or social network.

5. The user profile of claim 4, wherein a photo album within the user profile displays authentic designer handbags, apparel, jewelry, and/or accessories the users have purchased—the authenticity of which is verified by a representative who works for the respective designer's company.

6. The method of claim 4, wherein user profiles, or users of user profiles who are verified owners of authentic designer handbags, apparel, jewelry, and/or accessories are grouped into two or more categories to classify dollar amounts those users spent on authentic designer handbags, apparel, jewelry, and/or accessories featured in their user profile.

7. The method of claim 4, wherein users and user profiles of verified owners of authentic designer handbags, apparel, jewelry, and/or accessories can be searched for by the general public, via a search engine, using a user's name, location, or other personal identifying information.

8. A method of claim 7, wherein the search engine is offered only to a select group of users of the website or social network.

9. A method comprising, using a membership card or membership number (including alpha and alpha-numeric characters) to acknowledge and/or identify verified owners of authentic designer handbags, apparel, jewelry, and/or accessories.

10. The method of claim 9, in which the purpose of a membership card or membership number is to offer special discounts on products and services, retail transactions, and/or special treatment at places of business including, but not limited to restaurants, hotels, travel agents, airlines, resorts, vacations, car dealerships, banks, finance companies, grocery stores, spas, doctor offices, retail department stores, specialty retailers, jewelry stores, theaters, concerts, and/or sporting events.
